(19) United States
(12) Patent Application Publication
(10) Pub. No.: US 2026/0016072 A1
(43) Pub. Date: Jan. 15, 2026

(54) HYBRID ELECTRIC TRANSMISSION WITH SUPERCAPACITOR

(71) Applicant: INY LLC, The Woodlands, TX (US)

(72) Inventors: Christopher Buckley, Montgomery, TX (US); Brian Boguski, Milford, OH (US); Joseph McFarland, Newaygo, MI (US)

(21) Appl. No.: 19/266,513

(22) Filed: Jul. 11, 2025

Related U.S. Application Data
(60) Provisional application No. 63/670,055, filed on Jul. 11, 2024.

(51) Int. Cl. F16H 37/06; F16H 57/02; F16H 57/021; F16H 61/00; F16H 61/04; F16H 61/682

(52) U.S. Cl. CPC F16H 37/065; F16H 57/021; F16H 61/0437; F16H 61/682; F16H 2057/02034; F16H 2057/02073; F16H 2061/005

(57) ABSTRACT

An industrial power system includes a hybrid electric transmission assembly to transfer power from an internal combustion engine to an industrial load. The transmission assembly includes a first driveshaft coupled to the engine and a second driveshaft coupled to the load with a primary drivetrain gear assembly coupling the first driveshaft to the second driveshaft. An electric drive gearset is disposed along a primary axis spaced apart from the primary drivetrain gear assembly. An electric motor is couplable to the electric drive gearset, thereby allowing the electric motor to provide equilibrium power to the system during a gear change of the primary drivetrain gear assembly. The electric motors are energized at the beginning of a gear change by discharging a supercapacitor electrically coupled to the electric motors to minimize torque pulldown from the external load, after which a more stable supply of electricity is provided to the electric motors.

### CROSS-REFERENCE TO RELATED APPLICATIONS

This application claims priority to U.S. Provisional Pat. App. No. 63/670,055, filed Jul. 11, 2024, the disclosure of which is incorporated by reference herein in its entirety.

### TECHNICAL FIELD

This disclosure relates to operation of industrial equipment, and more particularly, to a hybrid electric transmission used to drive industrial equipment.

### BACKGROUND

Commonly, an internal combustion engine is utilized to drive large industrial and heavy equipment that require significant torque to operate. The power from such internal combustion engine is typically passed to such equipment, referred to herein as an external load, via a transmission assembly have one or more gearsets that can be utilized to alter the torque passing from the internal combustion engine to the external load. For example, a transmission may have six or more gearsets, such as a 1st gear, 2nd gear, 3rd gear, 4th gear, 5th gear and 6th gear, which are gradually utilized to bring the external load up to operational speed in order to achieve a desired output.

Examples of such an external load include industrial pumps utilized in a dam or water treatment facility, slurry pumps, hydraulic fracking pumps, marine propulsion systems, a vehicle propulsion systems, downhole equipment deployed in conjunction with a wellbore, generators, reciprocating pumps, and rotary pumps. In this regard, certain external loads may be classified as inertial systems, where motion or operation of the external load gradually bleeds off after power from the external power source driving the external load is removed, while other external loads may be classified as non-inertial systems, where motion or operation of the external load immediately terminates when power from the external power source driving the external load is removed. A reciprocating pump is one non-limiting example of a non-inertial system, whereas a ship propeller or rotary pump are non-liming examples of an inertial systems.

One drawback to these traditional systems is the drop-off in power to the external load during a gear change of the primary driving gear. During this drop-off in power, the torque placed on the primary driving gear by the external load may increase, called torque pulldown. This pulldown torque may be from the external load itself, or other systems with which the external load is engaged. This drawback is especially acute where the external load is a non-inertial load. A non-inertial load is a load where motion or operation of the external load immediately terminates when power from the external power source driving the external load is removed (as opposed to a load with motion or operation that gradually bleeds down once the power is removed). Such abrupt stoppage in operation, called non-inertial pulldown, even if it occurs only briefly, can negatively impact the transmission of power during the gear change. In fact, in extreme cases, non-inertial pulldown can result in stalling of the internal combustion engine since such internal combustion engines typically have a minimum operating speed (rpm), it being understood that the non-inertial pulldown as experienced by the internal combustion engine could cause the speed (rpm) of drop below minimum operating conditions. One specific example of a situation where non-inertial pulldown occurs is where a reciprocating pump is in fluid communication with a system, such as a wellbore or pressurized manifold, that places resistance pressure on the plunger of the reciprocating pump.

Thus, there is a need to minimize torque pulldown during operation of such large industrial and heavy industrial equipment driven by internal combustion engines.

### BRIEF DESCRIPTION OF THE DRAWINGS

For a more complete understanding of the present disclosure and its features and advantages, reference is now made to the following description, taken in conjunction with the accompanying drawings, in which:

FIG. 1a illustrates a power system having a hybrid electric transmission assembly with an electric motor radially offset from the primary driveline and powered by two electricity sources.

FIG. 1b illustrates one embodiment of an additional electricity source utilizing a plurality of supercapacitors to form a bank of supercapacitors.

FIG. 2 is similar to FIG. 1a, but illustrates multiple electric motors radially offset from the primary driveline.

FIG. 3 illustrates a power system having a hybrid electric transmission assembly with an electric motor powered by two electricity sources disposed to bypass the primary drive train gear assembly of the hybrid electric transmission assembly.

FIG. 4 is similar to FIG. 3, but illustrates multiple electric motors radially offset from the primary driveline.

FIG. 5 illustrates a power system having a hybrid electric transmission assembly with electric motors powered by two electricity sources and disposed to either power primary drive train gear assembly or bypass primary drive train gear assembly.

FIG. 6 illustrates a power system having a hybrid electric transmission assembly with an electric motor powered by two electricity sources and disposed to either power primary drive train gear assembly or bypass primary drive train gear assembly.

FIG. 7a is an axial view of one embodiment of two electricity sources energizing multiple electric motors radially offset from the primary driveline of a power system having a hybrid electric transmission assembly.

FIG. 7b is an axial view of another embodiment of two electricity sources energizing multiple electric motors radially offset from the primary driveline of a power system having a hybrid electric transmission assembly.

FIG. 7c is an axial view of another embodiment of two electricity sources energizing multiple electric motors radially offset from the primary driveline of a power system having a hybrid electric transmission assembly.

FIGS. 8a-8c illustrated different arrangements of supercapacitors, additional electricity sources and inverters for providing electricity to a plurality of electric motors.

FIG. 9 is an industrial power transmission power curve illustrating non-inertia pulldown during gear changes.

### DETAILED DESCRIPTION

Disclosed herein is an industrial power system having a hybrid electric transmission assembly disposed to transfer primary driving power from an internal combustion engine to an external load. The hybrid electric transmission assembly includes a first driveshaft and a second driveshaft extending along a transmission primary axis with a primary drivetrain gear assembly coupling the first driveshaft to the second driveshaft. An electric drive gearset, separate from the primary drivetrain gear assembly, is disposed along one of the first or second driveshafts and spaced axially apart from the primary drivetrain gear assembly. The first driveshaft is operatively coupled to the internal combustion engine and the second driveshaft is operatively coupled to the external load. At least one electric motor is couplable to the electric drive gearset. Where the electric drive gearset is positioned between the primary drivetrain gear assembly and the external load, power from the electric motor bypasses the primary drivetrain gear assembly for various operations, such as during a gear change in the primary drivetrain gear assembly. Where the electric drive gearset is positioned between the internal combustion engine and the primary drivetrain gear assembly, power from the electric motor(s) can be utilized to temporarily maintain the primary drivetrain gear assembly in at least an equilibrium state whereby torque in the primary drivetrain gear assembly is maintained for various operations, such as during a gear change in the primary drivetrain gear assembly. In other embodiments, an electric drive gearset may be disposed along the first driveshaft or second driveshaft and meshed with two or more radially offset electric motors, where the two or more radially offset electric motors are each disposed along a separate electric motor axis that is parallel with but spaced racially outward from the transmission primary axis. In some embodiments, the two or more radially offset electric motors are mounted on and supported by a transmission housing in which the primary drivetrain gear assembly is disposed. In all cases, at least one of the electric motors are electrically coupled to both at least one supercapacitor and an additional electricity source, whereby the supercapacitor is discharged at the beginning of a gear change to maintain or overcome an initial torque, thus minimizing torque pulldown, and the additional electricity source is utilized to maintain the desired power condition for the remainder of the gear change procedure. In some embodiments, the additional electricity source may be a bank of supercapacitors.

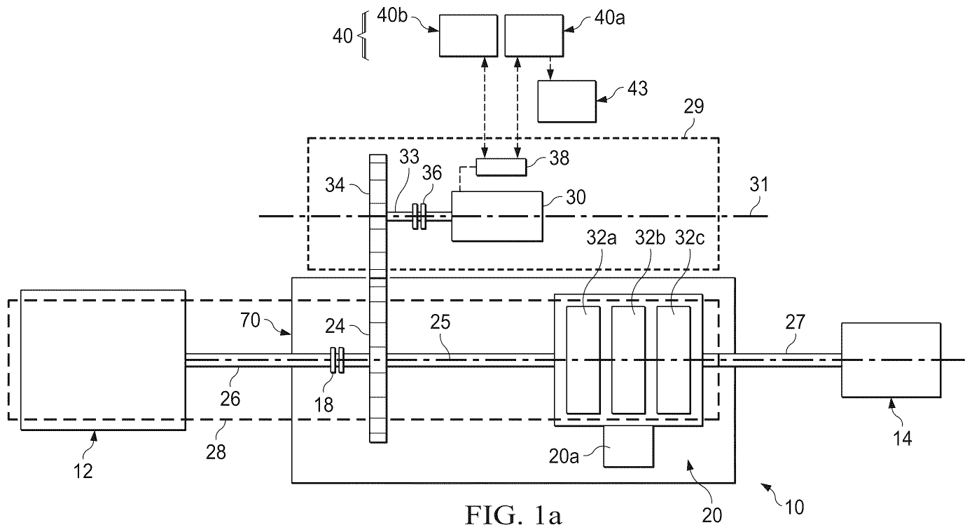

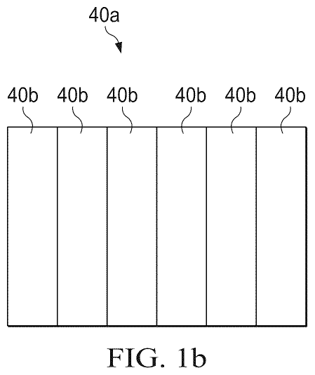

With reference to FIG. 1a, an industrial power system 8 is depicted. Power system 8 includes a hybrid electric transmission assembly 10 having a transmission primary axis 25 and disposed to couple an external power source 12 to an external load 14 via a first driveshaft 26 and a second driveshaft 27, respectively. In one or more embodiments, because of the physical size of external power source 12 and external load 14, first driveshaft 26 and second driveshaft 27 extend along the same transmission primary axis 25 in order to maximize power passed through the system. Hybrid electric transmission assembly 10 includes a transmission housing 70 enclosing a primary drivetrain gear assembly 20 coupled between first driveshaft 26 and second driveshaft 27.

Power system 8 utilizes one or more electric motors 30 external of transmission housing 70, which one or more electric motors 30 are radially offset from the primary driveline of the hybrid electric transmission assembly 10 to selectively provide power to hybrid electric transmission assembly 10 for the purposes described herein. FIG. 1a illustrates power system 8 with a single electric motor 30. In one or more embodiments, electric motor(s) 30 may be mounted or otherwise supported on an exterior surface of transmission housing 70. External power source 12 provides mechanical power to the hybrid electric transmission assembly 10 in order to drive external load 14.

In one or more embodiments, external power source 12 is an internal combustion engine, including without limitation, piston engines and gas turbines.

While external load 14 need not be limited to particular driven industrial equipment, in one or more embodiments, external load 14 is an inertial external load, which includes but is not limited to a rotary pump, while in other embodiments, external load 14 is a non-inertial external load, which may include, but is not limited to a reciprocating pump. In one or more embodiments, an inertial external load 14 may include but is not limited to a centrifugal pump. In one or more embodiments, an inertial external load 14 may include but is not limited to an electrical generator. In one or more embodiments, external load 14 may be downhole equipment deployed within a wellbore. In one or more embodiments, external load 14 may be drilling or production equipment deployed in conjunction with a wellbore. Additional examples of high-torque industrial equipment include drilling equipment, such as top drives and draw works of oil and gas rigs as well as rotary and percussive drill rigs used in mining; high-torque winch motors and slew drives for heavy duty cranes; rock crushers; SAG and ball mills used in mining; shredders and grinders; positive displacement pumps; mine hoists; winches and draw works; industrial mixers and agitators such as large tank agitators and cement mixers and concrete batch plant drives.

Hybrid electric transmission assembly 10 can include an engagement mechanism 18 to selectively engage and disengage external power source 12 from primary drivetrain gear assembly 20. In one or more embodiments, engagement mechanism 18 may be one or more clutches, clutch plates, shift mechanisms or other devices. In one or more embodiments, engagement mechanism 18 may be pneumatically activated, hydraulically activated or electrically activated. For example, engagement mechanism 18 may be an electric clutch, a hydraulic clutch or pneumatic clutch. Engagement mechanism 18 may be coaxial with first driveshaft 26 along transmission primary axis 25.

It will be understood that any particular driveshaft or other rotatable shaft as described herein may be formed of one or more rotatable shafts and need not be a single unitary shaft.

In one or more embodiments, external power source 12, input or first driveshaft 26, drive train gear assembly 20 and output or second driveshaft 27 are arranged along primary axis 25 and represent a primary drivetrain 28, while electric motor(s) 30 is disposed along a separate electric motor axis 31 and represents a secondary drivetrain 29 that is parallel with but spaced radially apart from primary axis 25 so as to be radially offset therefrom. In one or more embodiments, hybrid electric transmission assembly 10 may have a plurality of secondary drivetrains 29, each having an electric motor axis 31 with one or more electric motors 30 disposed therealong. In one or more embodiments, hybrid electric transmission assembly 10 may have at least three secondary drivetrains 29, each having an electric motor axis 31 with one or more electric motors 30 disposed therealong.

Disposed along the first driveshaft 26 and spaced axially apart from primary drivetrain gear assembly 20 along primary axis 25 is an electric drive gearset 24. In one or more embodiments, electric drive gearset 24 is disposed along first driveshaft 26 between engagement mechanism 18 and primary drive train gear assembly 20. In one or more embodiments, an electric drive gearset 24 may be intermittently coupled to first driveshaft 26. In one or more embodiments, electric drive gearset 24 may be coaxial with transmission primary axis 25. In one or more embodiments, electric drive gearset 24 may be a planetary gearset, while in other embodiments, electric drive gearset 24 may be one or more spur gears. In any event, electric drive gearset 24 is spaced axially apart from primary drive train gear assembly 20 so as not to be meshed with any gears or gearsets of primary drive train gear assembly 20.

Primary drive train gear assembly 20 includes one or more gearsets 32 that are selectable as the primary driving gear to transfer power from external power source 12 to external load 14. During a gear change within primary drive train gear assembly 20, the primary driving gear is shifted from one gearset 32 to another gearset 32 In some embodiments, primary drive train gear assembly 20 may include a plurality of gearsets 32. In some embodiments, primary drive train gear assembly 20 may include at least three gearsets 32a, 32b, 32c. Thus, for example, a gear change could result in the primary driving gear being changed from gearset 32a to gearset 32b. Where gearset 32a is a lower gear, such as first gear, and gearset 32b is a higher gear, such as second gear, the gear change from gearset 32a to gearset 32b as the primary driving gear would be an upshift in the primary driving gear from a lower gear to a higher gear. In other embodiments, the gear shift might be from a higher gear as the primary driving gear to a lower gear. Where primary drive train gear assembly 20 includes at least two gearsets 32, the gearsets may be coupled together. In some embodiments, primary drive train assembly 20 may include at least six gearsets. In some embodiments, primary drive train assembly 20 may include at least nine gearsets from which the primary driving gear may be selected through a gear change sequence.

In some embodiments of primary drive train assembly 20, one or more of the gearsets 32 may be a planetary gearset. In one or more embodiments, primary drive train gear assembly 20 is a planetary clutch having a plurality of gearsets 32 that are each a planetary gearset. In or more embodiments, primary drive train assembly 20 includes six planetary gearsets 32, although primary drive train assembly 20 may have more or fewer planetary gearsets 32.

Primary drive train gear assembly 20 may also include a shift mechanism 20a that can be actuated to shift between gearsets 32. The disclosure is not limited to a particular shift mechanism 20a for implementation of a gear change, but may include, among others, hydraulic, electric, or pneumatic shift mechanisms. In some embodiments, for example, shift mechanism 20a may hydraulically shift gearsets 32. In such case, hydraulic actuation allows the gear shift to be modulated in order to address the circumstance where a fast gear change may be needed in some situations.

In any event, the embodiments of hybrid electric transmission assembly 10 of FIG. 1a utilizes electric motor(s) 30 to provide equilibrium power (as opposed to driving power) to an output gearset 34 that is meshed with electric drive gearset 24, thereby minimizing pulldown forces from the external load 14 from impacting a gear change in primary drive train gear assembly 20 and also maintaining external load 14 in an equilibrium condition during the gear change.

In one or more embodiments, electric motor 30 includes an electric motor output shaft 33 extending along an electric motor axis 31 and on which output gearset 34 is mounted. More specifically, although external power source 12 when fully operational is used to provided driving power to hybrid electric transmission assembly 10 in order to drive external load 14, during a gear change, operation of hybrid electric transmission assembly 10 is handed off or transferred from external power source 12 to electric motor(s) 30 so that electric motor(s) 30 can provide equilibrium power to hybrid electric transmission assembly 10 during the gear change, it being understood that during such gear change, driving power transmitted to external load 14 is temporarily suspended. Rather, electric motor(s) 30 provide equilibrium power to drive train gear assembly 20. Engagement mechanism 18 may be actuated during the gear change to isolate external power source 12 from electric drive gearset 24 and primary drive train gearset 20.

In the context of a non-inertial load, where driving power is suspended or drops below a predetermined torque, a deadhead condition can result, which in prior art systems, such deadhead condition could be transferred back to the internal combustion engine, causing a possible stall of the internal combustion engine. In any event, in one or more embodiments of hybrid electric transmission assembly 10, during a change in the primary driving gearset 32 of drive train gear assembly 20, power from external power source 12 is temporarily suspended while electric motor(s) 30 are utilized to equilibrium power to drive train gear assembly 20.

As used herein, equilibrium power means that external load 14 is not being driven but held in a suspended state in order to minimize pulldown. For example, where external load 14 is a reciprocating pump, during a state of equilibrium power, plunger movement is suspended so that the reciprocating pump is not moving fluid. Rather, the pump is held in an equilibrium state, preventing forward movement of the plunger but also preventing backward movement of the plunger, so that the pump can be readily actuated upon completion of the gear change without having to overcome deadhead forces placed on the pump by the overall pressurized network. Once a gear change has been completed, operation of hybrid electric transmission assembly 10 is handed or transferred back to external power source 12 from electric motor(s) 30 so that external power source 12 can thereafter provide driving power to hybrid electric transmission assembly 10 in order to operate external load 14. Thus, the external power source 12 is not utilized during gear changes.

As such, the likelihood of the external power source 12 dropping below a “stall” rpm is minimized during gear change. For example, internal combustion engines utilized in certain high torque gear changes will stall when the operating speed of the internal combustion engine drops below 1350 revolutions per minute by virtue of the torque placed on the internal combustion engine by the external load 14. By utilizing electric motor(s) 30 to change gears in the hybrid electric transmission assembly 10, the speed of the decoupled external power source 12 can be kept above this stall threshold. It will be appreciated that in the embodiments of FIG. 1a, electric motor(s) 30 need not assist the external power source 12 in providing driving power to external load 14, but rather, temporarily replacing external power source 12 during a gear change to provide equilibrium power to hybrid electric transmission assembly 10. In those scenarios where electric motor(s) 30 are used to provide equilibrium power, external power source 12 is not utilized during gear change and driving power to external load 14 from external power source 12 is temporarily suspended.

In one or more embodiments, the at least one electric motor 30 of FIG. 1a is electrically coupled to a power source 40 comprising at least one supercapacitors 40b and an additional electricity source 40a to provide electricity to the electric motor 30, whereby the supercapacitor 40b is rapidly discharged at the beginning of a gear change in driveline gear assembly 20 to maintain or overcome an initial torque, and the additional electricity source 40a is utilized thereafter to maintain the desired power condition for the remainder of the gear change procedure. In one or more embodiments, the additional electricity source 40a may be a bank of supercapacitors 40b formed by a plurality of supercapacitors 40b electrically connected to one another. Where the additional electricity source 40a is a bank of supercapacitors 40b, it will be appreciated that the additional supercapacitor 40b may simply be one or more of the supercapacitors 40b making up the additional electricity source 40a. In any event, unlike other electricity sources such as batteries or even an electric grid, supercapacitors have a much higher discharge rate, delivering a burst of power not available from these other electricity sources. It is this initial burst of power achievable by the supercapacitor(s) that functions to minimize the impact of torque on the primary drivetrain gear assembly 20 during a gear change. Moreover, it is also the unique characteristic of a comparatively higher energy density of a supercapacitor that allows a smooth transition to a more stable flow of electricity from the additional electricity sources.

In one or more embodiment, the supercapacitor 40b may be adjacent the electric motor 30 to which it is electrically coupled. In this regard, the supercapacitor 40b may be mounted on or otherwise supported by the exterior surface of the transmission housing 70.

Although in some embodiments, additional electricity source 40a may be a plurality of supercapacitors 40b forming a bank of supercapacitors, additional electricity source 40a need not be limited to a particular source of electricity. In some embodiments, additional electricity source 40a may include local electricity storage, such as a battery 43, while in other embodiments, additional electricity source 40a may in the alternative or in addition thereto include a power grid or electric generator. In yet other embodiments, additional electricity source 40a may be a bank of supercapacitors 40b as well as one or more batteries 43.

The electric motor(s) 30 as depicted in FIG. a is utilized to assist during a change in gears within the drivetrain assembly 20 so that momentum in the operation of external load 14 is not lost during the gear change. In the case of inertial loads, this minimizes loss of momentum in the operation of external load 14 during the gear change as could occur during a gear change where external power source 12 is providing the driving power. In the case of non-inertial loads, this minimizes the likelihood of torque pulldown that could stall external power source 12 during the gear change as could occur during a gear change where external power source 12 is providing the driving power. To be clear, during a gear change within drivetrain gear assembly 20 as shown in FIG. 1a, driving operation of external load 14 may be temporarily suspended while electric motor(s) 30 provide equilibrium power the transmission assembly 10 to facilitate the gear change.

In one or more embodiments, electric motor 30 may also be an alternator or electric generator utilized to produce electricity from operation of external power source 12. This allows excess horsepower from external power source 12 to be utilized, particularly where the horsepower requirements for external load 14 are less than the horsepower capacity of external power source 12. For example, external power source 12 may be a diesel engine rated at 2500 horsepower (hp) whereas external load 14 may have an operating horsepower of 1700 hp. By utilizing electric motor 30 as a generator, the additional horsepower can be utilized to generate electricity that can be stored locally in by additional electricity source 40a in the form of a supercapacitor bank or one or more batteries 43 and/or utilized to recharge one or more supercapacitors 40b.

On the other hand, where the external power source 12 has a horsepower rating that is less than the horsepower rating of the external load 14, then electric motor 30 can be operated using electricity from additional electricity source 40a to provide the additional horsepower needed to meet the horsepower requirements of the external load 14. In the example utilized above, the external load 14 may have a horsepower rating greater than 2500 hp (such as 3000 hp), in which case, electric motors 30 can provide supplemental horsepower to hybrid electric transmission assembly 10 to make up the 500 horsepower difference. Notably, in such instances, both external power source 12 and electric motor(s) 30 are providing power to first driveshaft 26, with electric motor(s) 30 coupled to first driveshaft 26 downstream of engagement mechanism 18 (where present).

An engagement mechanism 36 may be provided to selectively engage and disengage electric motor 30 from output gearset 34 in order to isolate electric motor 30 from external power source 12, such as when external power source 12 is driving external load 14. In this regard, engagement mechanism 36 may be disposed along electric output shaft 33. In one or more embodiments, engagement mechanism 36 may be electrically activated, hydraulically activated or pneumatically activated.

The at least one electric motor 30 may be driven by an electric inverter 38. Electric inverter 38 may be utilized to energize electric motor 30, as well as control the speed or torque of electric motor 30. In some embodiments, each electric motor 30 has its own electric inverter 38, while in other embodiments, one electric inverter 38 electrically coupled to two or more electric motors 30 may be utilized to control the two or more electric motors 30. Moreover, electric inverter 38 may be utilized to manage the electricity delivered from each of the supercapacitor 40b as well as the additional electricity source 40a. It will be appreciated that inverter 38 is utilized to convert DC power from a supercapacitor 40b and/or battery 43 to AC power for the electric motor. Thus, while an inverter 38 may not be shown in each of the embodiments, an inverter 38 is utilized where the additional electricity source 40a is providing DC power. As an example, an inverter 38 is utilized where additional electricity source 40a is a bank of supercapacitors 40b.

In some embodiments, electric inverter 38 may also control the operation of shift mechanism 20a to coordinate a shift between gearsets 32 and energizing electric motors 30 for powering the gearchange. Thus, electric inverter 38 is electrically coupled to both the electric motor(s) 30 and the shift mechanism 20a to coordinate operation thereof during a gear change as described herein, it being appreciated that in order to achieve the results of minimizing non-inertia pulldown the energizing electric motor(s) 30 and initiating a gear change between gearsets 32 of primary drivetrain assembly 20 must be coordinated accordingly.

Similarly, because of the need to carefully coordinate operation of multiple electric motors 30 to provide power from at least additional electricity source 40a as described herein, in some embodiments, a single electric inverter 38 may be electrically coupled to a plurality of electric motors 30 so as to control the plurality of electric motors 30 simultaneously.

In one or more embodiments, one or more electric motors 30 may be axial flux electric motors. It will be appreciated that axial flux electric motors can readily be utilized as an electric motor to produce mechanical energy or as a generator to produce electricity. One advantage of axial flux motors is that they shorten the length of the overall footprint of the power system 8. In this regard, axial flux motors being shorter in axial length than a radial flux motor with the same power density, are more readily supported on transmission housing 70.

As described above, while additional electricity source 40a need not be limited to a particular electricity source, in some embodiments, additional electricity source 40a is a plurality of supercapacitors 40b electrically coupled to one another in series or parallel to give the desired output forming a bank of supercapacitors 40b as shown in FIG. 1b.

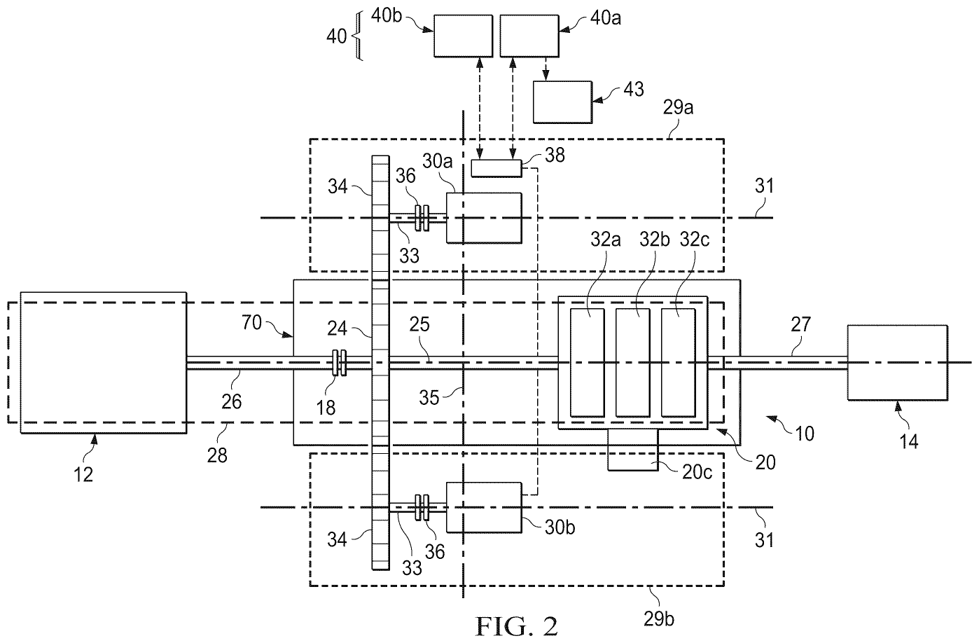

The hybrid electric transmission assembly 10 of FIG. 2 is similar to the hybrid electric transmission assembly 10 of FIG. 1a, but hybrid electric transmission assembly 10 of FIG. 2 includes at two electric motor 30a, 30b spaced radially outward from transmission primary axis 25, where each electric motor 30a, 30b includes an output gearset 34 that is meshed with electric drive gearset 24 disposed along first driveshaft 26. Because the plurality of electric motors 30a, 30b are each meshed with electric drive gearset 24, they can each utilize a different electricity source, as described below in some embodiments, while still supporting a gear change within primary drivetrain gear assembly 20. As with the electric motor 30 of FIG. 1a, electric motors 30a, 30b are mounted external to transmission housing 70. In one or more embodiments, electric motors 30a, 30b may be mounted or otherwise supported on an exterior surface of transmission housing 70. Electric motors 30a, 30b are arranged in parallel. In this vein, electric motors 30a, 30b may be operated in simultaneously in some embodiments, while in other embodiments, electric motor 30a, 30b may be operated in the alternative.

In some embodiments, the plurality of radially offset electric motors 30 may be disposed in a plane 35 that is perpendicular to transmission primary axis 25, thereby allowing each of the electric motors 30 to be more readily coupled to one of the input driveshaft 26 or the output driveshaft 27 utilizing a single electric drive gearset mounted thereon, such as electric drive gearset 24.

It will be appreciated that a plurality of smaller electric motors 30 as described in FIG. 2 are more desirable because of case of maintenance. Specifically, one electric motor 30 may be taken offline while the other electric motor(s) 30 can continue to operate as described herein, avoiding the need to interrupt operation of hybrid electric transmission assembly 10.

In this regard, a single, large electric motor needed to achieve a particular horsepower output to drive an external load 14 requiring over 700 horsepower may be cumbersome and have a large footprint for a skid mounted power system. Such a motor would typically be at least 1750 horsepower and of such a large size that it must be mounted coaxially along the driveshaft of a prior art transmission, increasing the overall physical length and footprint of the system with which it is used. In contrast, a plurality of comparatively smaller horsepower electric motors that are radially offset as described herein can be utilized to minimize the footprint of the industrial power system 8. In one non-limiting example, for instance, the “smaller” electric motors may be 50-100horsepower, while in other embodiments, the smaller electric motors may be 500 horsepower. In any event, the electric motors 30 may have a horsepower that is less than the single, large axially aligned electric motors of the prior art.

In addition, it will be appreciated that a plurality of electric motors 30 as described in FIG. 2 are more desirable because of the ability to quickly alter the electric motor power input during a particular gear change operation. In any event, the plurality of electric motors 30a, 30b, may operate in parallel so that each may be selectively meshed directly or indirectly to electric drive gearset 24. In addition, a plurality of comparatively smaller horsepower motors (as opposed to one large electric motor disposed along primary transmission primary axis 25 as common in the prior art) as anticipated in some embodiments can be readily mounted on transmission housing 70, in order minimizing the footprint of the power production system 8 while allowing both the electric motors 30 for gear changing and the external power source 12 for driving an external load 14 to be incorporated in a single, skid mounted system.

In one or more embodiments, external power source 12, input or first driveshaft 26, drive train gear assembly 20 and output or second driveshaft 27 are arranged along primary axis 25 and represent a primary drivetrain 28, while each of electric motors 30a, 30b are disposed along separate electric motor axis 31 and represent secondary drivetrains 29a, 29b, each of which is parallel with but spaced radially apart from primary axis 25 so as to be radially offset therefrom. Thus, in one or more embodiments, hybrid electric transmission assembly 10 may have a plurality of secondary drivetrains 29, each having an electric motor axis 31 with one or more electric motors 30 disposed therealong. In one or more embodiments, hybrid electric transmission assembly 10 may have at least three secondary drivetrains 29, each having an electric motor axis 31 with one or more electric motors 30 disposed therealong.

In any event, each electric motor 30 includes an electric motor output shaft 33 extending along an electric motor axis 31 and on which an output gear 34 is mounted. Moreover, in one or more embodiments, an engagement mechanism 36 may be provided to selectively engage and disengage electric motor 30 from output gearset 34. In this regard, an engagement mechanism 36 may be disposed along electric output shaft 33. In one or more embodiments, engagement mechanism 36 may be electrically activated, hydraulically activated, or magnetically or pneumatically activated. For example, engagement mechanism 36 may be an electric clutch, a hydraulic clutch or pneumatic clutch or magnetic clutch.

In one or more embodiments where two or more electric motors 30a, 30b are utilized, each electric motor 30a, 30b may be electrically coupled to both supercapacitor 40b and additional electricity source 40a. Alternatively, in one or more embodiments where two or more electric motors 30a, 30b are utilized, one electric motor 30a may be electrically coupled to supercapacitor 40b and one electric motor 30b may be electrically coupled to additional electricity source 40a where both supercapacitor 40b and additional electricity source 40a are both used to energize electric motors 30a, 30b during the gear change operation to provide equilibrium power to industrial power system 8 before driving power of the external load 14 is handed back to external power source 12. This allows one electric motor 30a, for example, to receive the quick discharge of the supercapacitor 40b to address initiation of the gearchange while the other electric motor 30b can provide ongoing power.

In yet other embodiments, each electric motor 30 may be coupled to at least one separate supercapacitor 40b. In this arrangement, multiple electric motors 30 may still all be electrically coupled to the same additional electricity source 40a (which may be bank of supercapacitors 40b) even though each of the electric motors 30a may be coupled to its own dedicated supercapacitor 40b.

In any of the foregoing arrangements, one or more inverters 38 may be utilized to manage power flow between the supercapacitors 40b, the additional electricity source 40a and the electric motors 30. In some embodiments, one inverter 38 may be utilized to manage power flow between each of the supercapacitors 40b and their respective electric motors 30, while a separate inverter 38 may be utilized to manage power flow between the electric motors 30 and the additional electricity source 40a. In other embodiments, each supercapacitor 40b may be electrically coupled to a separate inverter 38 that is in turn is electrically coupled to a separate electric motor 30, while another inverter 38 may be utilized to manage power flow between all of the electric motors 30 and the additional electricity source 40a.

Thus, when delivering power to external load 14 from an external power source 12 through the hybrid electric transmission assemblies 10 shown in FIGS. 1a and 2, upon the need for a gear change, the external power source 12 is decoupled from external load 14 while the electric motor(s) 30 are coupled to the external load 14 to implement the gear change before handing driving power back powering of the external load 14 to the external power source 12. In one or more embodiments, the electric motor(s) 30 during a gear change are powered first by the rapid discharge of a supercapacitor 40b in order to boost inertia or otherwise minimize torque pulldown and then by an additional electric supply 40a for ongoing power during the remainder of the gear change.

In other words, it will be appreciated that supercapacitor 40b provides a burst of instantaneous power (burst mode) at the beginning of a gear change operation, after which additional electricity source 40a, such as a battery 43 (or other external power source) provides power for the duration of the gear change operation. After discharge, supercapacitor 40b can be recharged by additional electricity source 40a, such as a battery 43 or electric grid (not shown) or generator (not shown) until the next gear change event.

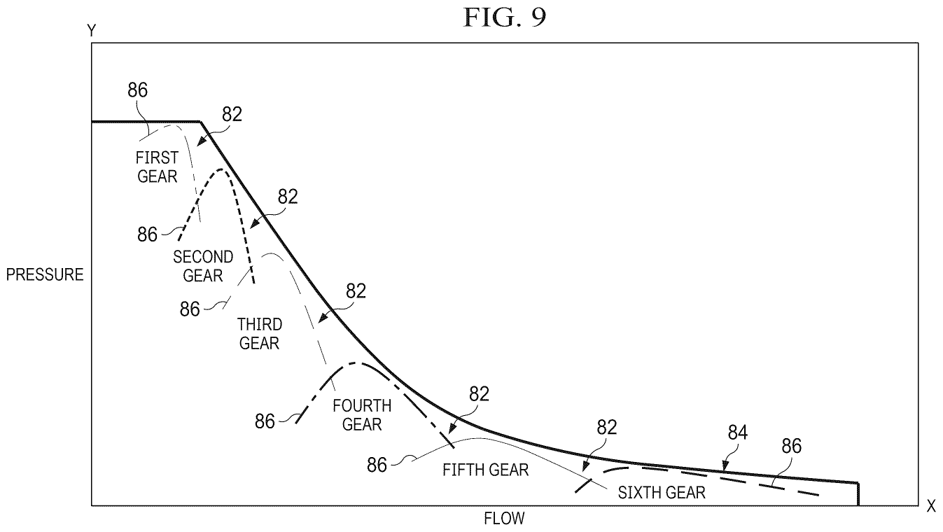

For any of the foregoing descriptions of FIGS. la and 2, during operation of an external load, an external power source is generally utilized to provide power to a transmission to drive the external load. At some point during operation of the external load, the need for a gear change in the transmission is identified. Prior to the gear change, operation of the external load is temporarily suspended by disengaging the external power source from driving the external load. At the same time the external source is disengaged from driving the external load, one or more electric motors are operated to provide equilibrium power to the transmission by discharging one or supercapacitors electrically coupled to one or more electric motors, thereby providing a burst of power to the one or more electric motors. The supercapacitor discharge is followed by a more continuous supply of electricity to the one or more electric motors to maintain the equilibrium power during the duration of the gear change. In any event, upon operation of the electric motors using at least the supercapacitors, gears of the transmission are changed while operating the electric motor to provide equilibrium power to the transmission. Following the gear change, the one or more electric motors are disengaged from providing power to the transmission. At the same time, the external power source is reengaged with the transmission, after which, the reengaged external power source is used to continue to provide driving power to the external load in operation thereof. In this arraignment, the one or more electric motors are operated during the gear change to minimize power lag as illustrated in FIG. 9. Moreover, the burst of power from discharge of the supercapacitors at the initiation of the gear change further mitigates any potential torque pulldown that could result therefrom. Such procedure can be utilized each time the transmission is upshifted or downshifted between gearing ratios.

Likewise, in another embodiment, during operation of an external load, an external power source is generally utilized to provide power to a transmission to drive the external load. During such operation, the need for a gear change in the transmission is identified. Prior to the gear change, operation of the external load is suspended by disengaging the external power source from driving the external load and engaging an electric motor to provide equilibrium power to the transmission. With the external power source disengaged, a gear change is initiated by discharging a supercapacitor to provide electricity to the electric motor. Contemporaneously with the supercapacitor discharge, or immediately thereafter, continuous electricity to the electric motors is provided for the duration of the gear change. Following completion of the gear change, the electric motor(s) is disengaged from providing equilibrium power to the transmission and the external power source is reengaged with the transmission, after which the reengaged external power source is utilized to provide driving power to the external load.

Thus, a gear change may be initiated by discharging at least one supercapacitor electrically coupled to each of the plurality of electric motors by energizing the electric motors at the initiation of a gearchange by discharging the supercapacitor. Following the discharge of the supercapacitor(s), a more stable supply of electricity is utilized to energize the electric motors for the remainder of the gear change. In this regard, stable refers to a more constant supply of electricity with a constant voltage supply to the electric motors over a discreet period as compared to a capacitor discharge that has a rapidly decreasing voltage supply over a discreet period of time. In some embodiments, the more constant supply of electricity may be from the controlled discharge of a plurality of supercapacitors forming a supercapacitor bank.

It will further be appreciated that following the gear change and prior to the next gear change, the one or more supercapacitors are recharged. Recharging the supercapacitors between gear changes can be accomplished utilizing an additional electricity source, including but not limited to batteries electrically coupled to the capacitors, a generator electrically coupled to the capacitors or an electric grid.

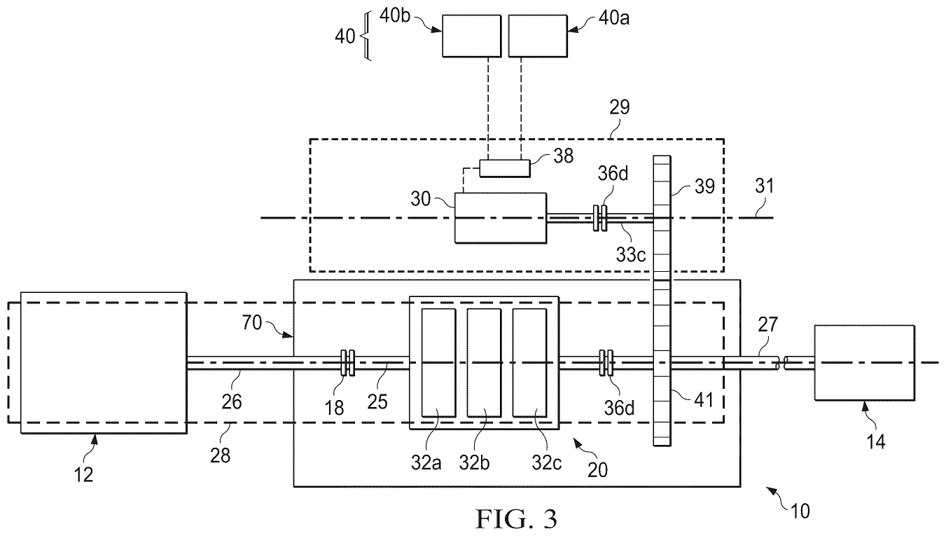

FIG. 3 illustrates another embodiment of hybrid electric transmission assembly 10 in which at least one electric motor(s) 30 is coupled directly to output driveshaft 27, bypassing the primary drive train assembly 20. Electric motor 30 of FIG. 3 is external to transmission housing 70, and may be mounted or otherwise supported on an exterior surface of transmission housing 70. The at least one electric motor 30 of FIG. 3 is electrically coupled to both a supercapacitor 40b and an additional electricity source 40a to provide electricity to the electric motor 30. In this embodiment, where additional electricity source 40a includes a bank of supercapacitors 40b, then the separate supercapacitor 40b may be eliminated. Unless otherwise stated, components and functions of numbered parts in FIG. 3 is similar to those descriptions above with respect to FIGS. 1a and 2, which discussion is incorporated herein.

Optionally, external power source 12, input driveshaft 26, drive train gear assembly 20 and output driveshaft 27 are arranged along primary axis 25 and represent a primary drivetrain 28, while one or more electric motor(s) 30 are disposed along one or more separate electric motor axis 31 and represents one or more secondary drivetrains 29 that are parallel with but spaced radially apart from primary axis 25 so as to be radially offset therefrom.

Electric motor 30 includes an electric output shaft 33c extending along electric motor axis 31 and along which an output gearset 39 is disposed. In some embodiments, output gearset 39 may be a gear mounted on output shaft 33c. Output gearset 39 in turn is meshed or otherwise coupled to an electric drive gearset 41 to operate drive output driveshaft 27 while bypassing drive train assembly 20. In one or more embodiments, electric drive gearset 41 may be a planetary gearset, while in other embodiments, electric drive gearset 41 may be one or more spur gears.

An engagement mechanism 36c may be provided along output shaft 33c to selectively engage and disengage electric motor 30 from output gearset 39. In some embodiments, it may be desirable to actuate engagement mechanism 36c to disengage and selectively isolated electric motor 30 from output driveshaft 27 when external power source 12 is driving external load 14.

In other embodiments, it may be desirable to actuate engagement mechanism 36c to be engaged so that output driveshaft 27, through output gearset 39 and electric drive gearset 41, can be used not only to drive external load 14 using external power source 12, but also to drive electric motor 30 for the purposes of generating electricity. In this regard, electric motor 30 may be a generator, and used to produce electricity for delivery to one or both of supercapacitor 40b and additional electricity source 40a (such as a battery). It will be appreciated that in such embodiments, electric motor 30 becomes part of the overall load that is driven by external power source 12 and thus, primary drive train gear assembly 20 is also used to moderate power transmission to electric motor 30. This avoids placing any additional load on external power source 12 upstream of the primary drive train gear assembly 20.

Engagement mechanism 36d may be provided to decouple primary drive train gear assembly 20 from output driveshaft 27 when electric motor 30 is used to provide power to output driveshaft 27. In this way, primary drive train gear assembly 20 is selectively isolated from external load 14 and will not inhibit power output from electric motor 30. In one or more embodiment, engagement mechanism 36d may include any of the engagement mechanisms disclosed herein. For example, electric motor 30 may provide power to external load 14 during a gear change in primary drive train gear assembly 20, wherein the supercapacitor 40b is initially discharged to electric motor 30 to address the significant torque that could be experienced from pull down, and then additional electricity source 40a is utilized to provide ongoing electricity to electric motor 30 after any potential torque pull down has been overcome.

Thus, additional electric motor 30 may be utilized to directly power external load 14 for directly driving external load 14, bypassing primary drive train assembly 20.

Electric drive gearset 41 is shown disposed along second driveshaft 27 between external load 14 and primary drivetrain gear assembly 20. In or more embodiments, electric drive gearset 41 may be coaxial with second driveshaft 27 along transmission primary axis 25.

As shown in FIG. 3, the electric motor(s) 30 are external to transmission housing 70, positioned radially outward from transmission primary axis 25 along which power input driveshaft 26 extending from external power source 12 is positioned. In one or more embodiments, electric motor 30 may be supported on or otherwise attached to an exterior surface of transmission housing 70.

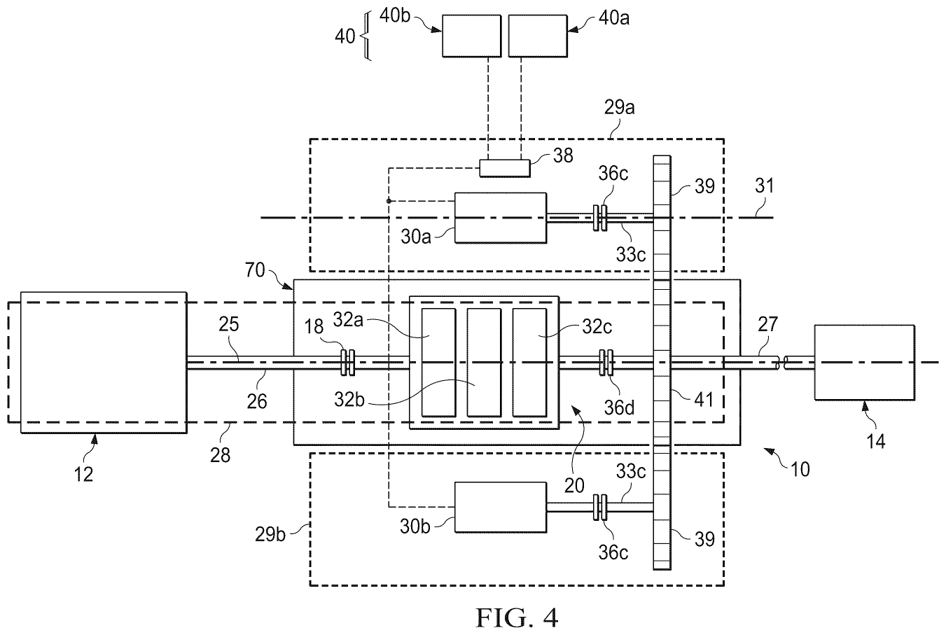

The hybrid electric transmission assembly 10 of FIG. 4 is similar to the hybrid electric transmission assembly 10 of FIG. 3, but hybrid electric transmission assembly 10 of FIG. 4 includes at two electric motor 30a, 30b spaced radially outward from transmission primary axis 25, where each electric motor 30a, 30b includes an output gearset 39 that is meshed with electric drive gearset 41 disposed along second driveshaft 27. At least one of the electric motors 30a, 30b is electrically coupled to supercapacitor 40b and at least one electric motor 30a, 30b is electrically coupled to the additional electricity source 40a. Because the plurality of electric motors 30a, 30b are each meshed with electric drive gearset 41, they can each utilize a different electricity source, as described below in some embodiments.

In one or more embodiments, external power source 12, input or first driveshaft 26, primary drive train gear assembly 20 and output or second driveshaft 27 are arranged along primary axis 25 and represent a primary drivetrain 28, while each of electric motors 30a, 30b are disposed along separate electric motor axis 31 and represent secondary drivetrains 29a, 29b, each of which is parallel with but spaced radially apart from primary axis 25 so as to be radially offset therefrom. Thus, in one or more embodiments, hybrid electric transmission assembly 10 may have a plurality of secondary drivetrains 29, each having an electric motor axis 31 with one or more electric motors 30 disposed therealong. In one or more embodiments, hybrid electric transmission assembly 10 may have at least three secondary drivetrains 29, each having an electric motor axis 31 with one or more electric motors 30 disposed therealong.

As with the electric motor 30 of FIG. 3, electric motors 30a, 30b are mounted external to transmission housing 70. In one or more embodiments, electric motors 30a, 30b may be mounted or otherwise supported on an exterior surface of transmission housing 70. In any event, as shown, electric motors 30a, 30b in the embodiments of FIG. 3 are arranged in parallel. In this vein, electric motors 30a, 30b may be operated simultaneously in parallel in some embodiments, while in other embodiments, electric motors 30a, 30b may be operated in the alternative.

It will be appreciated that a plurality of smaller electric motors 30 as described in FIG. 4 are more desirable because of case of maintenance. Specifically, one electric motor 30 may be taken offline while the other electric motor(s) 30 can continue to operate as described herein, avoiding the need to interrupt operation of hybrid electric transmission assembly 10. This can allow multiple electric motors 30 to be utilized to provide power to electric drive gearset 41, similar to illustrated FIG. 2 with respect to electric drive gearset 24.

In one or more embodiments, each of the two or more electric motors 30a, 30b may be electrically coupled to both supercapacitor 40b and additional electricity source 40a. Alternatively, in one or more embodiments where two or more electric motors 30a, 30b are utilized, one electric motor 30, such as electric motor 30a, may be electrically coupled to supercapacitor 40b and one electric motor 30, such as electric motor 30b may be electrically coupled to additional electricity source 40a. This allows one electric motor 30a, for example, to receive the quick discharge of the supercapacitor 20b to address torque issues while the other electric motor 30b, for example, may have a more continuous supply of electricity for providing driving power to external load 14 when primary drivetrain gear assembly 20 is bypassed for a gear change.

In one or more embodiments, the additional electricity source 40a may be a bank of supercapacitors 40b formed by a plurality of supercapacitors 40b electrically connected to one another. Where additional electricity source 40a is a bank of supercapacitors 40b, it will be appreciated that the additional supercapacitor 40b may simply be one or more of the supercapacitors 40b making up the additional electricity source 40a.

For any of the foregoing descriptions of FIGS. 3 and 4, during operation of an external load, an external power source is generally utilized to provide power to a transmission to drive the external load. At some point during operation of the external load, the need for a gear change in the transmission is identified. Prior to the gear change, operation of the external load is temporarily suspended by disengaging the transmission from transferring driving power the external load. At the same time the external load is disengaged from driving power from the transmission, one or more electric motors are operated to provide power to the external load by discharging one or supercapacitors electrically coupled to one or more electric motors, thereby providing a burst of power to the one or more electric motors. The supercapacitor discharge is followed by a more continuous supply of electricity to the one or more electric motors to maintain the power to the external load during the duration of the gear change. In any event, upon operation of the electric motors using at least the supercapacitors, gears of the transmission are changed while operating the electric motor to provide power to the external load while the transmission is disengaged from the external load. Following the gear change, the one or more electric motors are disengaged from providing power to the external load. At the same time, the transmission is reengaged with the external load, after which, the reengaged external power source is used to continue to provide driving power to the external load in operation thereof. In this arraignment, the one or more electric motors are operated during the gear change to minimize power lag as illustrated in FIG. 9. Moreover, the burst of power from discharge of the supercapacitors at the initiation of the gear change further mitigates any potential torque pulldown that could result therefrom. Such procedure can be utilized each time the transmission is upshifted or downshifted between gearing ratios.

Likewise, in another embodiment, during operation of an external load, an external power source is generally utilized to provide power to a transmission to drive the external load. During such operation, the need for a gear change in the transmission is identified. Prior to the gear change, operation of the external load is suspended by disengaging the transmission from providing driving power to the external load and engaging one or more electric motors with the external load to provide power to the external load. With the transmission disengaged from the external load, a gear change is initiated by discharging a supercapacitor to provide electricity to the one or more electric motors. Contemporaneously with the supercapacitor discharge, or immediately thereafter, continuous electricity to the electric motors is provided for the duration of the gear change. Following completion of the gear change, the electric motor(s) is disengaged from providing power to the external load and the transmission is reengaged with the external load, after which the external power source through the reengaged transmission is utilized to provide driving power to the external load.

In another embodiment, during operation of an external load, an external power source is generally utilized to provide power to a transmission to drive the external load. During such operation, the need for a gear change in the transmission is identified. Prior to the gear change, operation of the external load is suspended by disengaging the external power source from driving the external load and engaging at least one electric motor to provide power to the external load. Thereafter, a gear change in the transmission is initiated by discharging a supercapacitor to energize the at least one electric motor. Following discharge or contemporaneously with at least a portion of the discharge, an additional electricity source is utilized to continue to energize the at least one electric motor for the duration of the gear change. Upon completion of the gear change, the at least one electric motor is disengaged from providing power to the external load and the external power source is reengaged with the external load. Thereafter, the reengaged external power source is utilized to provide driving power to the external load through the transmission.

Thus, a gear change may be initiated by discharging at least one supercapacitor electrically coupled to each of the plurality of electric motors by energizing the electric motors at the initiation of a gearchange by discharging the supercapacitor. Following the discharge of the supercapacitor(s), a more stable supply of electricity is utilized to energize the electric motors for the remainder of the gear change. In this regard, stable refers to a more constant supply of electricity with a constant voltage supply to the electric motors over a discreet period as compared to a capacitor discharge that has a rapidly decreasing voltage supply over a discreet period of time. In some embodiments, the more constant supply of electricity may be from the controlled discharge of a plurality of supercapacitors forming a supercapacitor bank.

It will further be appreciated that following the gear change and prior to the next gear change, the one or more supercapacitors are recharged. Recharging the supercapacitors between gear changes can be accomplished utilizing an additional electricity source, including but not limited to batteries electrically coupled to the capacitors, a generator electrically coupled to the capacitors or an electric grid.

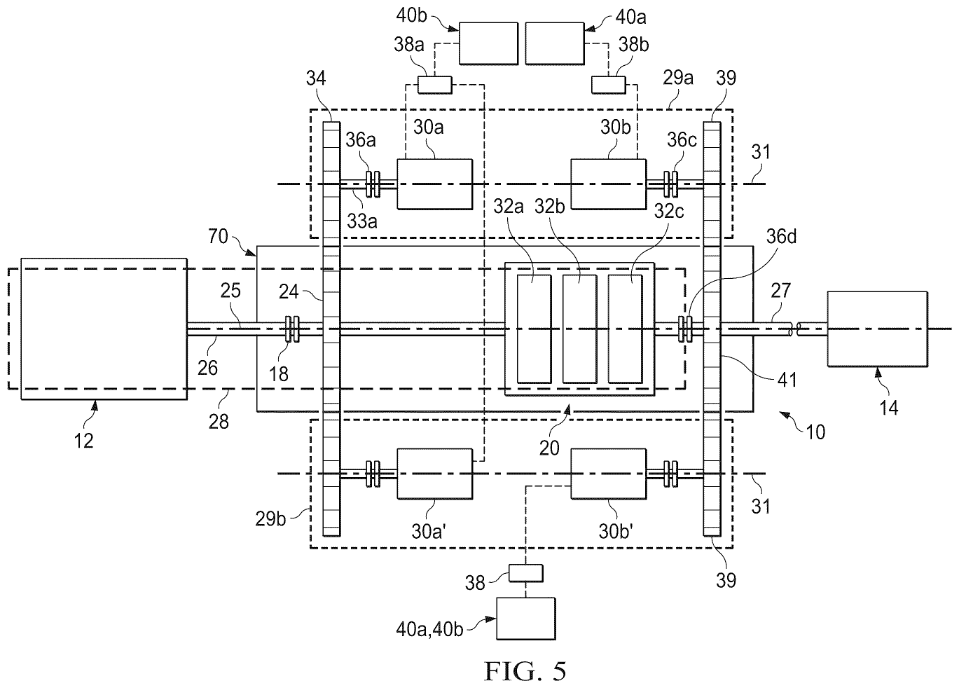

The hybrid electric transmission assembly 10 disclosed in FIG. 5 is similar to hybrid electric transmission assembly 10 disclosed in FIGS. 1a, 2-4, but includes an electric drive gearset 24 mounted on the first driveshaft 26 which electric drive gearset 24 is coupled to a first electric motor 30a, and an electric drive gearset 41 mounted on the second driveshaft 27 which electric drive gearset 41 is coupled to a second electric motor 30b. One electric motor(s) 30a may be utilized to provide power to electric drive gearset 24 and a separate electric motor 30b may be utilized to provide power to electric drive gearset 41. In one or more embodiments, supercapacitor 40b may be electrically coupled to electric motor 30a, while additional electricity source 40a may be electrically coupled to electric motor 30b. Thus, supercapacitor 40b may be used in conjunction with electric motor 30a to overcome any significant increase in torque in primary drivetrain gear assembly 20 resulting from a deadhead condition during a gear change, while additional electricity source 40a may be used in conjunction with electric motor 30b to provide power to external load 14 during the gear change.

In one or more embodiments, external power source 12, input or first driveshaft 26, primary drive train gear assembly 20 and output or second driveshaft 27 are arranged along primary axis 25 and represent a primary drivetrain 28. Electric motors 30a, 30b are disposed along an electric motor axis 31 and represent a secondary drivetrain 29a which is parallel with but spaced radially apart from primary axis 25 so as to be radially offset therefrom. In one or more embodiments, one or more additional secondary drivetrains 29, such as secondary drivetrain 29b, may be defined, where the additional secondary drivetrain 29b includes an electric motor axis 31 with one or more electric motors 30 disposed therealong. In the illustrated embodiment, secondary drivetrain 29b includes electric motors 30a′, 30b′ that are each coupled to electric drive gearset 24 and electric drive gearset 41, respectively. Thus, in one or more embodiments, hybrid electric transmission assembly 10 such as is illustrated in FIG. 5 may have a plurality of secondary drivetrains 29.

Supercapacitor 40b is electrically coupled to at least one of electric motors 30a, 30b of FIG. 5, and additional electricity source 40a is electrically coupled to at least one of electric motors 30a, 30b of FIG. 5. In the illustrated embodiment, in secondary drivetrain 29a, supercapacitor 40b is electrically coupled to first electric motor 30a, while additional electricity source 40a is electrically coupled to second electric motor 30b. This arrangement allows supercapacitor 40b to be utilized with electric motor 30a to prevent torque pulldown in primary drivetrain gear assembly 20 during a gear change, while electric motor 30b can be utilized to provide equilibrium power or driving power to external load 14 during the gear change. In this arrangement, activation of electric motors 30a, 30b can occur simultaneously since each electric motor 30a, 30b is providing a separate task.

In other embodiments, each electric motor 30a, 30b may be electrically coupled to each of supercapacitor 40b and additional electricity source 40a.

In one or more embodiments, the additional electricity source 40a may be a bank of supercapacitors 40b formed by a plurality of supercapacitors 40b electrically connected to one another. Where additional electricity source 40a is a bank of supercapacitors 40b, it will be appreciated that the additional supercapacitor 40b may simply be one or more of the supercapacitors 40b making up the additional electricity source 40a.

Where two or more secondary drivetrains 29 are provided, such as secondary drivetrains 29a 29b, one electric motor 30 coupled to of the electric drive gearsets 24, 41 may be powered by a supercapacitor 40b and the other electric motor 30 coupled to the electric drive gearset 24, 41 may be powered by, i.e., in electrical communication with, the other electric drive gearset 24, 41.

As described above, one or more electric inverters 38 may be utilized in conjunction with supercapacitor 40b and additional electricity source 40a. In one or more embodiments, a single electric inverter 38 may be electrically coupled to multiple electric motors 30a, 30b. In one or more other embodiments, each electric motor 30a, 30b may have its own electric inverter 38, such as electric inverters 38a, 38b used with electric motor 30a, 30b, respectively, in FIG. 5.

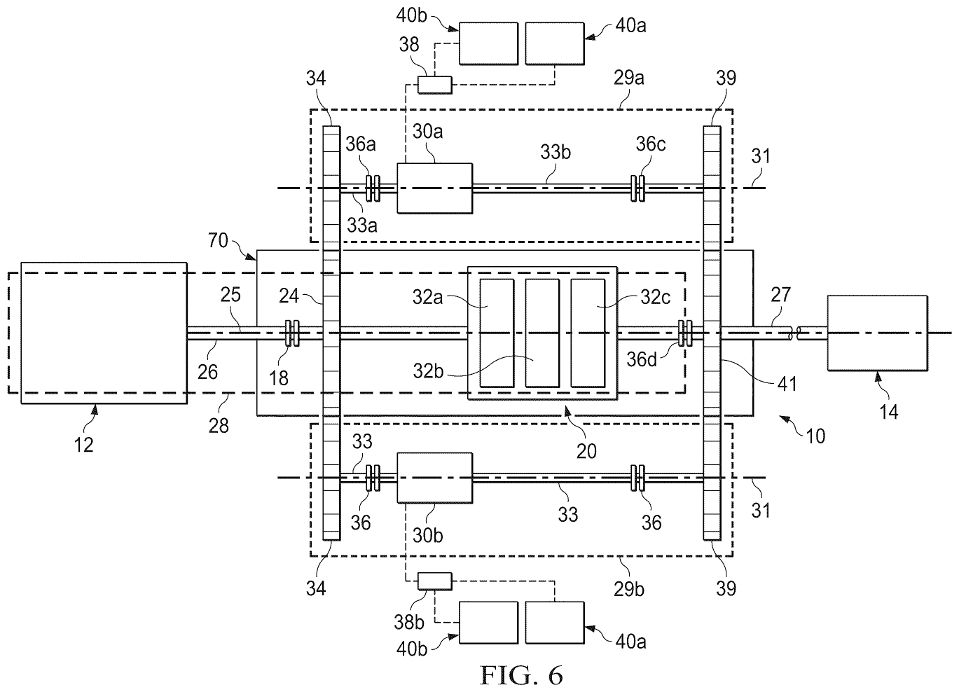

The hybrid electric transmission assembly 10 disclosed in FIG. 6 is similar to hybrid electric transmission assembly 10 disclosed in FIG. 5, but where at least one secondary drivetrain 29, such as secondary drivetrain 29a, includes a single electric motor 30a having dual electric motor output shafts 33a, 33b allowing the single electric motor 30a to be coupled either to electric drive gearset 24 or to electric drive gearset 41 as desired. It will be appreciated that engagement mechanisms 36, such as engagement mechanisms 36a, 36c and 36d, may be utilized to selectively isolate electric motor 30a when coupled with either electric drive gearset 24 or electric drive gearset 41. In one or more embodiments, supercapacitor 40b is electrically coupled to electric motor 30a, and additional electricity source 40a is electrically coupled to electric motor 30a. Thus, supercapacitor 40b may be used in conjunction with electric motor 30a via electric drive gearset 24 to overcome any significant increase in torque in primary drivetrain gear assembly 20 resulting from a deadhead condition during a gear change, while additional electricity source 40a may be used in conjunction with electric motor 30a via electric drive gearset 41 to provide power to external load 14.

In one or more embodiments, external power source 12, input or first driveshaft 26, primary drive train gear assembly 20 and output or second driveshaft 27 are arranged along primary axis 25 and represent a primary drivetrain 28. Electric motor 30a is disposed along an electric motor axis 31 and represents a secondary drivetrain 29a which is parallel with but spaced radially apart from primary axis 25 so as to be radially offset therefrom. In one or more embodiments, one or more additional secondary drivetrains 29, such as secondary drivetrain 29b, may be defined, where the additional secondary drivetrain 29b includes an electric motor axis 31 with one or more electric motors 30 disposed therealong. In the illustrated embodiment, secondary drivetrain 29b includes electric motor 30b and is similar to electric motor 30a in that it has two electric motor output shafts 33 that are each couplable to electric drive gearset 24 and electric drive gearset 41, respectively. Thus, in one or more embodiments, hybrid electric transmission assembly 10 such as is illustrated in FIG. 6 may have a plurality of secondary drivetrains 29.

Supercapacitor 40b is electrically coupled to at least one of electric motors 30a, 30b of FIG. 6, and additional electricity source 40a is electrically coupled to at least one of electric motors 30a, 30b of FIG. 6. In the illustrated embodiment, each electric motor 30a, 30b is electrically coupled to each of supercapacitor 40b and additional electricity source 40a. In one or more embodiments, the additional electricity source 40a may be a bank of supercapacitors 40b formed by a plurality of supercapacitors 40b electrically connected to one another. Where additional electricity source 40a is a bank of supercapacitors 40b, it will be appreciated that the additional supercapacitor 40b may simply be one or more of the supercapacitors 40b making up the additional electricity source 40a.

Alternatively, where two or more secondary drivetrains 29 are provided, such as secondary drivetrains 29a 29b, one electric motor 30 coupled to of the electric drive gearsets 24, 41 may be powered by a supercapacitor 40b and the other electric motor 30 coupled to the electric drive gearset 24, 41 may be powered by, i.e., in electrical communication with, the other electric drive gearset 24, 41.

As described above, one or more electric inverters 38 may be utilized in conjunction with supercapacitor 40b and additional electricity source 40a. In one or more embodiments, a single electric inverter 38 may be electrically coupled to multiple electric motors 30a, 30b. In one or more other embodiments, each electric motor 30a, 30b may have its own electric inverter 38.

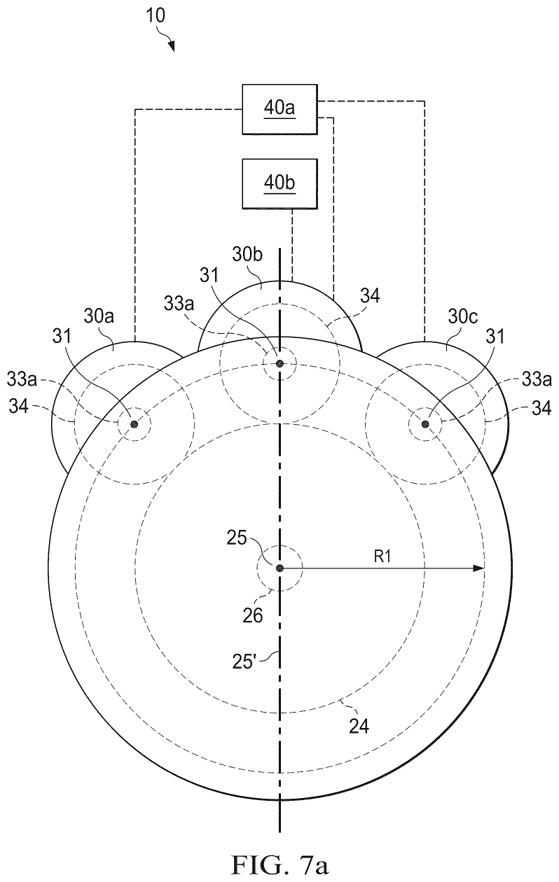

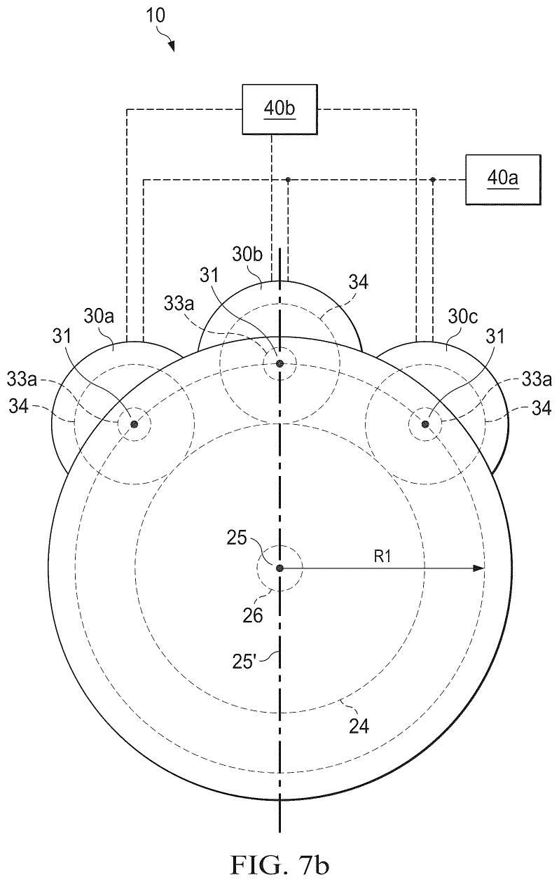

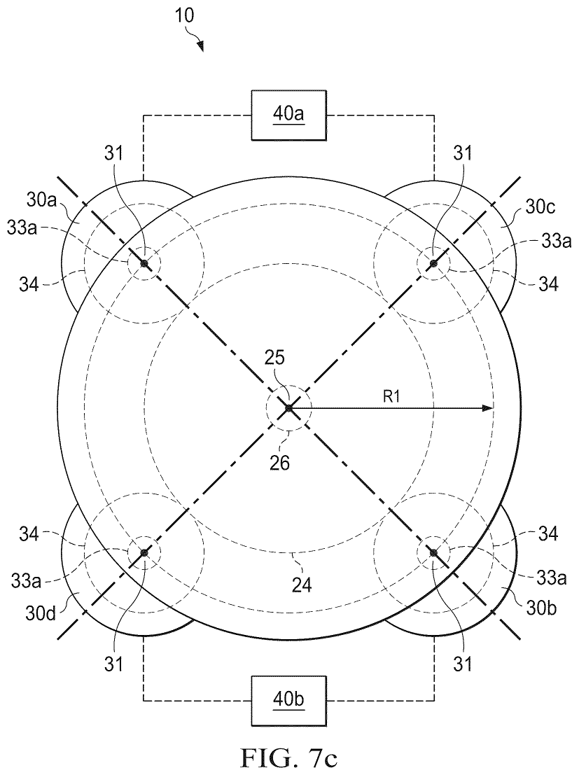

FIGS. 7a-7c illustrate embodiments of hybrid electric transmission assembly 10 as described above where a plurality of radially offset electric motors 30 are employed in hybrid electric transmission assembly 10 with a supercapacitor 40b electrically coupled to at least one of electric motors 30 and an additional electricity source 40a electrically coupled to at least one of the electric motors 30. In one or more embodiments, the plurality of electric motors 30 may be symmetrically spaced about primary axis 25, while in other embodiments, electric motors 30 may be symmetrically spaced about a vertical plane 25′ in which primary axis 25 is defined. It should be noted that in FIGS. 7a-7c, for case of understanding, inverters are omitted but would otherwise be included as described above, to manage conversion and distribution of power.

While some embodiments of hybrid electric transmission assembly 10 may use only a single radially offset electric motor 30 such as shown in FIG. 1a or two radially offset electric motors 30 such as is shown in FIG. 2, as best seen in FIGS. 7a, 7b and 7c, in some embodiments, hybrid electric transmission assembly 10 may include a plurality of radially spaced apart electric motors 30, such as electric motors 30a, 30b, 30c 30d, each disposed along its own electric motor axis 31 that extends parallel with primary axis 25 and parallel with the other electric motor axii 31. In any of these embodiments, however, the electric motor(s) 30 are spaced radially outward from axis 25 so that axii 31 of the respective electric motors 30a, 30b, 30c, 30d are parallel with output driveshaft 27 and transmission primary axis 25, as well as with one another.

FIGS. 7a-7c illustrate different arrangements of supercapacitor 40b and additional electricity source 40a with electric motors 30 disposed about transmission primary axis 25 and/or plane 25′, regardless of whether the electric motors 30 are meshed with electric drive gearset 24 (see FIG. 2) or electric drive gearset 41 (see FIG. 4).

In FIGS. 7a and 7b, electric motors 30a, 30b and 30c are positioned adjacent one another about transmission primary plane 25′, while in FIG. 7c, electric motors 30 are spaced symmetrically about transmission primary axis 25.

In FIG. 7a, additional electricity source 40a is in electrical communication with all of the electric motors 30a, 30b, 30c, while supercapacitor 40b is only in electrical communication with only electric motor 30b. Of course, in embodiments where the additional electricity source 40a is a bank of supercapacitors 40b formed by a plurality of supercapacitors 40b electrically connected to one another, the additional supercapacitor 40b may simply be one or more of the supercapacitors 40b making up the additional electricity source 40a.

In FIG. 7b, additional electricity source 40a is in electrical communication with all of the electric motors 30a, 30b, 30c, and supercapacitor 40b is in electrical communication with all of the electric motors 30a, 30b, 30c. In this embodiment, rather than having a single supercapacitor 40b electrically coupled to each electric motor 30a, 30b, 30c, each electric motor may have a one or more supercapacitors 40b coupled to it, while the same additional electricity source 40a is in electrical communication with all of the electric motors 30a, 30b, 30c. In one or more embodiments of this example, additional electricity source 40a may be an AC power source, such as an electrical grid.

In FIG. 7c, additional electricity source 40a is in electrical communication with a first portion of the electric motors 30a, 30c, while one or more supercapacitors 40b are in electrical communication with a second portion of the electric motors 30b, 30d.

It will be appreciated that in each of the various embodiments described above with respect to FIGS. 7a-7c, one or more inverters 38 (not show) may be utilized to manage power flow between the electric motors 30, the supercapacitors 40b and the additional electricity source 40a.

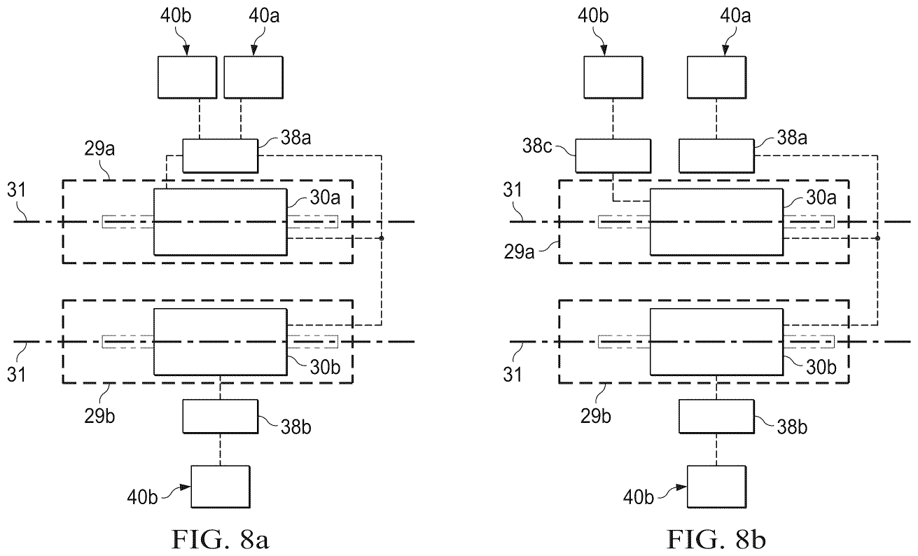

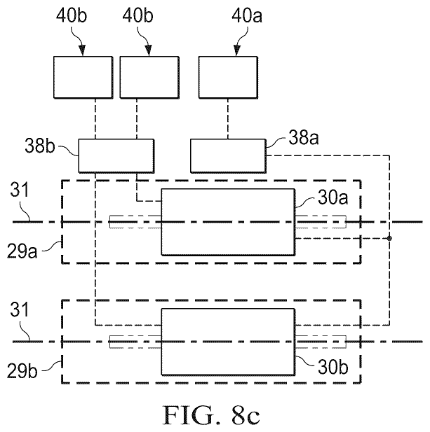

Similar to FIGS. 7a-7c, FIGS. 8a-8c illustrate various arrangements for supercapacitors 40b and the additional electricity source 40a when used with two or more electric motors 30a, 30b. Generally illustrated in FIGS. 8a-8c is at least two electric motors 30a, 30b are provided, where each of the at least two electric motors 30 is disposed along a separate electric motor axis 31 that is spaced apart from the other electric motor axis (as well as the primary axis 25, not shown) as described above. Each electric motor 30a, 30b includes an electric output shaft 33 extending along the respective electric motor axis 31.

In FIG. 8a, a separate supercapacitor 40b is provided for each electric motor 30, while each electric motor 30 is powered by the same additional electricity source 40a. Specifically, each separate supercapacitor 40b is dedicated to delivering burst of power to its respective electric motor 30a, 30b, while additional electricity source 40a is provided to deliver ongoing power to the electric motors 30a, 30b.

In FIG. 8b, each electric motor 30a, 30b is shown as having its own dedicated supercapacitor 40b and inverter 38c, 38b, respectively, to deliver a burst of power to the respective electric motors 30a, 30b, while additional electricity source 40a operates in conjunction with inverter 38a to control all or the electric motors 30a, 30b. In this embodiment, for example, additional electricity source 40a may be an electrical grid, a bank of supercapacitors 40b as described above, one or more batteries 43 or a combination of any of the foregoing, amount other types of electricity sources.

In FIG. 8c, two or more supercapacitors 40b are shown operating in conjunction with inverter 38b, to deliver power to each of electric motors 30a, 30b, while additional electricity source 40a operates in conjunction with inverter 38a to deliver power to each of the electric motors 30a, 30b. In this embodiment, the two or more supercapacitors 40b electrically coupled to inverter 38a together function as a supercapacitor bank. In this embodiment, for example, additional electricity source 40a may be one or more batteries 43 such as is shown in FIG. 1a, or some other electricity source, such as an electric power grid.

As used throughout the disclosure, a “supercapacitor”, also called an ultracapacitor, is a high-capacity capacitor, with a capacitance value much higher than solid-state, electrolytic capacitors but with lower voltage limits, having the high-power discharge of a capacitor with energy storage of a battery system. Because a super capacitor can accept a charge much faster than traditional capacitors or batteries, it is desirable as described herein for use in gear changes, which may occur faster than the time required for recharging a battery or traditional capacitor. Moreover, a supercapacitor tolerates many more charge and discharge cycles as compared to traditional capacitors or rechargeable batteries, lending itself to the many gear changes (see FIG. 9) that may occur in the hybrid electric transmission assembly 10 as described herein.

Unlike ordinary capacitors that use conventional solid dielectric to store a charge electrically, supercapacitors use electrostatic double-layer capacitance (EDLC) or electrochemical pseudocapacitance or a hybrid of the two to store a charge electrostatically, resulting in a capacitance in the thousands of farads and having an energy density of greater than 1 Wh/kg, often higher than 5 Wh/kg. In one or more embodiments, the supercapactiors described herein have a energy density greater than 5 Wh/kg. In one or more embodiments, the supercapactiors described herein have a energy density in the range of 8.0-11.1 Wh/kg with a capacitance of 3400-5000 F.

Moreover, while supercapacitors can provide a burst of energy when discharged, because such supercapacitors are known to have low voltage limits, it will be appreciated that the supercapacitors as described herein must be paired, in some embodiments, with an additional electricity source for ongoing electricity delivery. As described above, in one or more embodiments, this additional electricity source may be a bank of supercapacitors electrically connected to one another.

As used throughout the disclosure, any reference to a “gearset” shall mean one or more gears through which rotational force is transferred, which one or more gears may include, but are not limited to spur gears and planetary gears.

As used herein, unless otherwise stated, any electric motor may also function as an electric generator.

Unless otherwise described, an output shaft 33 of an electric motor 30 may be internal or external to the electric motor 30. Likewise, output gearsets 34 and 39 may be internal or external to the electric motor 30.

Unless otherwise described, references to an electric motor 30 may include two or more or a plurality of electric motors 30 each electric motor disposed along a separate electric motor axis 31 that is spaced radially outward from transmission primary axis 25.

Furthermore, where a hybrid electric transmission assembly 10 includes two or more electric motors 30 each extending along a separate radially spaced electric motor axis 31 but both meshed to the same drive gearset, such as illustrated in FIG. 4, such two or more electric motors 30 may be operated in parallel or in the alternative depending on the power requirements of hybrid electric transmission assembly 10. For example, where each of such electric motors 30 individually have a smaller horsepower output than is required of an external load 14 but collectively have a horsepower output that is equal to or greater than the horsepower requirements of external load 14, the multiple electric motors 30 may be operated in parallel.

FIG. 9 illustrates the potential impact of hybrid electric transmission assembly 10 in operation of a non-inertial external load 14. Typically, during a gear change of a transmission, power output to the external load 14 from an external power source, such as external power source 12 is temporarily interrupted, causing a lag in power as depicted by areas 82 under power curve 84. Where the external load 14 is an inertial external load 14, the external load 14 will continue to have momentum during the power interruption where the momentum helps carry the external load 14 during the gear change, thus overcoming the lag in power experienced by the external load 14 during the gear change. In other words, the inertial external load causes a gradual bleed-off of power from the external power source 12 when the driving force is removed. In such case, areas 82 under the power curve 84 are minimized. Once the gear change is complete, the power from external power source 12 may then be readily increased without the need to overcome torque from a dead stop of the external load. In the instance of a non-inertial external load 14 however, a dead head situation can occur where the external load causes an immediate termination of power from the external power source 12 upon removal of the driving force. In such case, areas 82 under the power curve 82 increase. By utilizing the plurality of electric motors 30 of hybrid electric transmission assembly 10, areas 82 under the power curve 82 can be minimized for non-inertial external loads 14, it being understood that the faster the gear ratio can be changed and implemented, the less likely a stall condition for external power source 12.

For example, in the case where external load 14 is a reciprocating pump producing fluid flow (output) against an external pressure (load) on the pumped fluid (which external pressure may be caused by other interconnected reciprocating pumps or other external pressure sources), during a gear change for the reciprocating pump, there can be a gear change power lag. During the power lag, the effective pressure from the other interconnected pumps and/or external pressure source causes a back pressure on the reciprocating pump to which the gear change is applied, resulting in bog down of such reciprocating pump. Such pump bog down is shown in the graph as areas 82 under power curve 84, between the power curve 84 and the individual gear curves 86. These areas 82 represent inefficiency in the overall transmission system.

It will be appreciated that hybrid electric transmission assembly 10 maximizes energy transition efficiency by using the power from a plurality of electric motor(s) 30 to minimize power lag and the resulting pump bog down. In the graph, the vertical “Y” axis is pressure (load), and the horizontal “X′ axis is flow (output). The reciprocating pump 14 produces flow, pumping a liquid or mixture over a given amount of time. The pressure in the reciprocating pump 14 and hybrid electric transmission assembly 10 is the resistance to flow. The result of Pressure x Flow is Horsepower (HP) and can also be quantified in kW. As the reciprocating pump 14 and hybrid electric transmission assembly 10 are used to increase flow, they start off in a low gear to maximize torque against a higher pressure. As electric transmission assembly 10 shifts through the gears, the output of reciprocating pump 14 increases in speed (rpm) resulting in a higher flow rate. In the hybrid electric transmission assembly 10, during a gear change, energy output from the one or more electric motors 30 is utilized to minimize non-inertial pulldown represented by the power lag areas 82. In other words, by handing off power to electric motors 30 during a gear change when power to external load 14 is temporarily suspended, and thereafter, handing back power to the external power source 12 when power to external load 14 is resumed, the power lag 82 during a gear change as described above is minimized.

Power curve 84 is illustrative of gear changes for all of the various transmission assemblies 10 discussed above with respect to the Figures, regardless of the electric power source 40 providing electric power for the duration of the gear change operation.

Thus, an industrial power system has been described.

Optionally, the industrial power system may include an internal combustion engine; a external load; a hybrid electric transmission assembly having a first driveshaft, a second driveshaft, a primary drivetrain gear assembly coupling the first driveshaft to the second driveshaft, and a electric drive gearset disposed along the second driveshaft, the first driveshaft operatively coupled to the internal combustion engine and the second driveshaft operatively coupled to the external load; at least one electric motor couplable to the electric drive gearset; and a supercapacitor bank electrically coupled to the electric motor.

Optionally, the industrial power system may include an internal combustion engine having a power input driveshaft and a start gearset coupled to the power input driveshaft; an external load; a hybrid electric transmission assembly having a first driveshaft, a second driveshaft, a primary drivetrain gear assembly coupling the first driveshaft to the second driveshaft, the first driveshaft operatively coupled to the power input driveshaft of the internal combustion engine and the second driveshaft operatively coupled to the external load; an electric motor couplable to the start gearset of the internal combustion engine; a supercapacitor electrically coupled to the electric motor; and also an additional electricity source electrically coupled to the electric motor.

Optionally, the industrial power system may include an internal combustion engine; an external load; a hybrid electric transmission assembly having a first driveshaft extending along a transmission primary axis, a second driveshaft extending along a transmission primary axis, a primary drivetrain gear assembly coupling the first driveshaft to the second driveshaft, and a transmission housing having a first end and a second end and enclosing the primary drivetrain gear assembly, with the first driveshaft extending from the first end of the housing and operatively coupled to the internal combustion engine, and the second driveshaft extending from the second end of the housing and operatively coupled to the external load; a plurality of electric motors each couplable to at least one of the first and second driveshafts, each electric motor disposed to drive a separate electric output shaft extending along separate electric motor axii, wherein the electric motor axii of the plurality of electric motors is parallel with but spaced radially outward from the transmission primary axis; and a supercapacitor bank electrically coupled to each of the plurality of electric motors.

Optionally, the industrial power system may include an internal combustion engine; an external load; a transmission housing having a first end and a second end with a power input shaft extending from the first end and an output driveshaft extending from the second end with the power input shaft coupled to the internal combustion engine and the output driveshaft coupled to the external load; a drive train assembly disposed in the transmission housing and coupling the power input shaft to the output driveshaft; a electric drive gearset coupled to one of the input shaft or the output driveshaft; at least two electric motors mounted on the transmission housing and each of the at least two electric motors coupled to the electric drive gearset; a supercapacitor electrically coupled to each of the electric motors; and an additional electricity source electrically coupled to each of the electric motors.

Optionally, the industrial power system may include an internal combustion engine; an external load; a transmission housing having a first end and a second end with a power input shaft extending from the first end and an output driveshaft extending from the second end with the power input shaft coupled to the internal combustion engine and the output driveshaft coupled to the external load; a drive train assembly disposed in the transmission housing and coupling the power input shaft to the output driveshaft; a electric drive gearset coupled to one of the input shaft or the output driveshaft; a plurality of electric motors mounted on the transmission housing, each of the plurality of electric motors couplable to the electric drive gearset; and a supercapacitor bank electrically coupled to each of the plurality of electric motors, wherein the supercapacitor bank comprises a plurality of supercapacitors electrically coupled to one another.

Any of the foregoing embodiments of an industrial power system may include alone or in combination, any of the following:

The internal combustion engine, power input shaft and output driveshaft are aligned along a transmission primary axis.
The external load is selected from the group consisting of drilling equipment, top drives, draw works, rotary drill rigs, percussive drill rigs, winches, slew drives, rock crushers, grinding mills, ball mills, shredders, grinders, positive displacement pumps, mine hoists, mixers, and agitators.
The electric drive gearset is mounted on the first driveshaft.
The electric drive gearset is mounted on the second driveshaft between the primary drivetrain gear assembly and the external load.
The electric drive gearset is mounted on the first driveshaft between the primary drivetrain gear assembly and the internal combustion engine.
An engagement mechanism disposed along the first driveshaft between the electric drive gearset and the internal combustion engine to selectively decouple the internal combustion engine from the first driveshaft during a gear change of the primary drivetrain gear assembly.
An engagement mechanism disposed along the second driveshaft between the second electric drive gearset and the primary drivetrain gear assembly to selectively decouple the second driveshaft from the primary drivetrain gear assembly.
An electrical inverter electrically coupling the capacitor bank to a plurality of electric motors, each electric motor radially spaced outward from the primary drivetrain axis.
An electrical inverter electrically coupling at least one of said electric motors to at least one supercapacitor.
The primary drivetrain gear assembly comprises at least a first gearset, a second gearset and a third gearset.
The first driveshaft and the second driveshaft extend along a transmission primary axis and the electric motor axis is parallel with but spaced radially outward from the transmission primary axis.
An output gearset driven by the electric output shaft and meshed with the electric drive gearset.
The drive train assembly comprises at least nine planetary gearsets.
The drive train assembly comprises a plurality of planetary gearset.

Likewise, a method for operating an industrial power system has been described.

Optionally, the method may include utilizing a first gearset as the primary driving gear of a primary drivetrain gear assembly to pass driving power from an internal combustion engine to an external load; initiating a gear change by i) isolating the primary drivetrain gear assembly from the external load by decoupling the primary drivetrain gear assembly from the powering the external load, and ii) driving the external load with an electric motor during the gear change by discharging a plurality of supercapacitors electrically coupled to the electric motor; engaging as the primary driving gear a second gearset of the primary drivetrain gear assembly while the primary drivetrain gear assembly is still isolated and the external load is being driven by the electric motor; and coupling the second gearset to the external load and driving the external load utilizing the second gearset of the transmission to pass driving power from the internal combustion engine to the external load.

Optionally, the method may include driving an external load utilizing a first gearset as the primary driving gear of a primary drivetrain gear assembly to pass driving power from an internal combustion engine to the external load; initiating a gear change by i) utilizing an electric motor to provide equilibrium power to an external load by discharging a plurality of supercapacitors electrically coupled to the electric motor; and ii) suspending driving power from the internal combustion engine to the external load; engaging as the primary driving gear a second gearset of the primary drivetrain gear assembly while equilibrium power is passed to the external load; and thereafter, driving the external load utilizing the second gearset of the transmission to pass driving power from the internal combustion engine to the external load.

Optionally, the method may include driving an external load utilizing a first gearset as the primary driving gear of a primary drivetrain gear assembly to pass driving power from an internal combustion engine to the external load; initiating a gear change by i) utilizing an electric motor to provide equilibrium power to an external load by discharging at least one supercapacitor electrically coupled to the electric motor; utilizing an additional electricity source to continue to operate the electric motor following discharge of the supercapacitor; and ii) suspending driving power from the internal combustion engine to the external load; engaging as the primary driving gear a second gearset of the primary drivetrain gear assembly while equilibrium power is passed to the external load by the electric motor; removing equilibrium power transmission from the electric motor to the external load; and thereafter, driving the external load utilizing the second gearset of the transmission to pass driving power from the internal combustion engine to the external load.

Any of the foregoing methods for operating an external load may include alone or in combination, any of the following:
Decoupling the electric motor from driving the external load once the second gearset is coupled to the external load.
The gear change from the first gearset to the second gearset as the primary driving gear is an upshift in gears.
Utilizing the transmission to change gears at least once during operation of the external load, wherein the electric motor is operated during the gear change to reduce torque pulldown.
Utilizing rapid discharge of a supercapacitor to minimize torque pulldown during a transmission gear change.
Utilizing rapid discharge of a supercapacitor over a first period of time followed by delivery of electricity from a supercapacitor bank over a second period of time longer than the first period of time to minimize torque pulldown during a transmission gear change.

Although various embodiments have been shown and described, the disclosure is not limited to such embodiments and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

1. (canceled)

2. The industrial power system of claim 7, wherein the another one of the at least two electric motors is electrically coupled to only the at least one additional electricity source.

3. The industrial power system of claim 7, wherein each of the at least two electric motors is electrically coupled to both the supercapacitor and the additional electricity source.

4. The industrial power system of claim 7, comprising at least three electric motors, each of the at least three electric motors supported on the exterior surface of the transmission housing and each having an electric output shaft extending along an electric motor axis that is parallel with but spaced radially outward from the transmission primary axis with an output gearset mounted on the electric output shaft and meshed with the electric drive gearset; wherein each of the at least three electric motors is electrically coupled to both the supercapacitor and the additional electricity source.

5. The industrial power system of claim 7, wherein the additional electricity source comprises a supercapacitor bank having a plurality of supercapacitors electrically coupled to one another.

6. The industrial power system of claim 7, wherein the external load is selected from the group consisting of drilling equipment, top drives, draw works, rotary drill rigs, percussive drill rigs, winches, slew drives, rock crushers, grinding mills, ball mills, shredders, grinders, positive displacement pumps, mine hoists, mixers; and agitators.

7. An industrial power system comprising:
an internal combustion engine;
an external load;
a hybrid electric transmission assembly having a first driveshaft, a second driveshaft, a primary drivetrain gear assembly having at least a first gearset, a second gearset and a third gearset, the primary drivetrain gear assembly coupling the first driveshaft to the second driveshaft with at least one of the first and second driveshafts extending along a transmission primary axis, and an electric drive gearset disposed along the primary drivetrain axis separate from the primary drivetrain gear assembly, the electric drive gearset mounted on either the first driveshaft or the second driveshaft and spaced axially apart from the primary drivetrain gear assembly along the primary drivetrain axis, the first driveshaft operatively coupled to the internal combustion engine and the second driveshaft operatively coupled to the external load;
a transmission housing having an exterior surface and enclosing the primary drivetrain gear assembly and the electric drive gearset and from which the first driveshaft and the second driveshaft extend; at least two electric motors, each of the at least two electric motors supported on the exterior surface of the transmission housing and each of the at least two electric motors having an electric output shaft extending along a respective electric motor axis, where each electric motor axis of the at least two electric motors is parallel with but spaced radially outward from the transmission primary axis with an electric output gearset mounted on the electric output shaft of each of the at least two electric motors, each electric output gearset meshed with the electric drive gearset; and
a supercapacitor and an additional electricity source, wherein one of the at least two electric motors is electrically coupled to the supercapacitor and the at least one additional electricity source and another one of the at least two electric motors is electrically coupled to the at least one additional electricity source.

8. The industrial power system of claim 7, wherein each of the two electric motors is electrically coupled to a plurality of supercapacitors.

9. The industrial power system of claim 8, wherein each electric motor is electrically coupled to a separate supercapacitor and each electric motor is electrically coupled to the same additional electricity source.

10. (canceled)

11. (canceled)

12. The industrial power system of claim 5, wherein the supercapacitor bank includes the supercapacitor.

13. A method for operating an industrial power system to drive an external load, the method comprising:
utilizing an external power source to provide power to a transmission to drive the external load;
identifying the need for a gear change in the transmission;
prior to the gear change, temporarily suspending operation of the external load by disengaging the external power source from driving the external load;
at the same time the external power source is disengaged from driving the external load, operating one or more electric motors to provide equilibrium power to the transmission by discharging a supercapacitor electrically coupled to the one or more electric motors, thereby providing a burst of power to the one or more electric motors;
following discharge of the supercapacitor, providing an on-going supply of electricity to the one or more electric motors to maintain the equilibrium power during the duration of the gear change;
following the gear change, disengaging the one or more electric motors from providing equilibrium power to the transmission and reengaging the external power source with the transmission; and
using the reengaged external power source to continue to provide driving power to the external load in operation thereof.

14. The method of claim 13, further comprising discharging a plurality of supercapacitors to provide the on-going supply of electricity to the one or more electric motors during the duration of the gear change.

15. The method of claim 13, further comprising following the gear change and prior to the next gear change, recharging the supercapacitor.

16. The method of claim 13, further comprising initiating the gear change by discharging at least one supercapacitor electrically coupled to each of the one or more electric motors.

17. The method of claim 13, further comprising providing power to the plurality of electric motors during a gear change utilizing a supercapacitor bank having a plurality of supercapacitors electrically coupled to one another.

18. The method of claim 13, further comprising energizing the electric motors when initiating the gear change by discharging the supercapacitor.

19. The method of claim 18, further comprising following discharge of the supercapacitor, providing the electric motors with a more stable supply of electricity for the remainder of the gear change.

20. The industrial power system of claim 7, wherein the electric drive gearset is mounted on the first driveshaft.

21. The method of claim 17, wherein the plurality of supercapacitors of the supercapacitor bank includes the supercapacitor.

22. A method for operating an industrial power system to drive an external load, the method comprising:
utilizing an external power source to provide power to a transmission to drive the external load;
identifying the need for a gear change in the transmission;
prior to the gear change, disengaging the external power source from driving the external load;
following disengagement of the external load, initiating the gear change in the transmission by discharging one or more supercapacitors to drive one or more electric motors to power the transmission during the gear change;
following discharge of the one or more supercapacitors, providing an on-going supply of electricity to the one or more electric motors from another source of electricity other than the discharged one or more supercapacitors to maintain power to the transmission during the duration of the gear change;
following the gear change, disengaging the one or more electric motors from providing power to the transmission and reengaging the external power source with the transmission; and
using the reengaged external power source to continue to provide driving power to the external load in operation thereof.

23. The method of claim 22, further comprising discharging a plurality of supercapacitors to provide the on-going supply of electricity to the one or more electric motors during the duration of the gear change.

24. The method of claim 22, further comprising recharging, after the gear change and prior to a next gear change, the supercapacitor.

25. The method of claim 24, wherein the supercapacitor is recharged using the another source of electricity.

26. The method of claim 25, wherein the another source of electricity is a supercapacitor bank comprising a plurality of supercapacitors, a battery, a generator, or an electric grid.

27. The method of claim 22, further comprising initiating the gear change by discharging the one or more supercapacitors electrically coupled to each of the one or more electric motors.

28. A method for operating an industrial power system to drive an external load, the method comprising:
providing, using an external power source, power to a transmission;
driving, using the transmission, the external load;
initiating a gear change in the transmission comprising:
disengaging the external power source from the transmission to temporarily suspend the driving of the external load using the transmission; and
discharging one or more supercapacitors electrically coupled to at least two electric motors coupled to the transmission to provide power to the at least two electric motors to power the transmission during the gear change;
performing the gear change in the transmission comprising:
changing gears in the transmission; and
providing, after the discharge of the one or more supercapacitors, an on-going supply of power to the at least two electric motors from an additional electricity source different from the discharged one or more supercapacitors to maintain power to the transmission during the duration of the gear change;
disengaging, after the gear change, the at least two electric motors from providing power to the transmission;
reengaging the external power source with the transmission; and
using the reengaged external power source to continue to provide driving power to the external load in operation thereof.

29. The method of claim 28, wherein disengaging the external power source form the transmission and discharging the one or more supercapacitors occur simultaneously.

30. The method of claim 28, wherein disengaging the at least two electric motors from providing power to the transmission and reengaging the external power source with the transmission occur simultaneously.

31. The method of claim 28, further comprising recharging, after the gear change and prior to a next gear change, the one or more supercapacitors.

32. The method of claim 31, wherein the one or more supercapacitors are recharged using the additional electricity source.

33. The method of claim 32, wherein the additional electricity source is a supercapacitor bank comprising a plurality of supercapacitors, a battery, a generator, or an electric grid.
